(19) United States
(12) Patent Application Publication
(10) Pub. No.: US 2010/0114844 A1
(43) Pub. Date: May 6, 2010

(54) METHOD AND SYSTEM FOR DATA MASHUP IN COMMENTING LAYER

(76) Inventor: WUZHEN XIONG, Shangai (CN)

Correspondence Address: SAP AG, 3410 HILLVIEW AVENUE, PALO ALTO, CA, 94304, US

(21) Appl. No.: 12/264,447

(22) Filed: Nov. 4, 2008

(51) Int. Cl. G06F 17/00; G06F 7/00

(52) U.S. Cl. 707/693; 707/E17.005

(57) ABSTRACT

Disclosed is a method and system for receiving an instruction for data mashup in a commenting layer, generating a list of fields in the commenting layer available for the data mashup, receiving a user selection for a first field from the list of fields, determining a data provider to provide a first data of the first field, obtaining the first data from the data provider, determining an aggregation function for the first data and a second data of a second field in the commenting layer and generating an aggregated data in the commenting layer by performing a data mashup operation on the first field and the second field based on the aggregation function.

### FIELD OF THE INVENTION

The invention generally relates to the field of presenting information in an enterprise application. More particularly, the invention relates to data mashup techniques in an enterprise application.

### BACKGROUND OF THE INVENTION

Data mashup is a technique to combine data from multiple sources and present the combined data to an end user. The data may be combined from various heterogeneous sources including enterprise systems, internet, intranet, maps, Wikipedia and blogs. The currently available data mashup tools require a user to have certain amount of technical knowledge and expertise to use them. These data mashup tools are typically used by someone with advanced skill levels such as an application developer and are typically not designed for use by end users who have little or no technical knowledge or expertise to perform a data mashup. Also, most of these tools are crude and incapable of performing data mashup dynamically.

Moreover, data mashup tools that are available today for end users are typically presentation layer data mashup tools. Also, most of the mashup tools and content are focused on consumer uses such as social networking, maps, advertising and so on. There has been very little to speak of what is done regarding leveraging this exciting technology in the enterprise world. Moreover, generally speaking, the presentation layer data mashup tools that are available are fairly inflexible and do not allow a user to create new mashups based on what they see on a presentation layer, for instance. Thus, a novice or a casual user is limited to the choices hard coded by the developers of the mashup tool. Accordingly, all that is available today to a casual user are superficial features such as changing the layout of data displayed in the mashup user interface, removing an existing piece of information from the mashup user interface, adding a similar piece of information, and personalizing the information displayed. What is needed are data mashup techniques for enterprise systems that are accessible to casual business users that allow them to dynamically add or modify information in enterprise data such as sales reports.

### SUMMARY OF THE INVENTION

Described are methods and systems for receiving an instruction for data mashup in a commenting layer, generating a list of fields in the commenting layer available for the data mashup, receiving a user selection for a first field from the list of fields, determining a data provider to provide a first data of the first field, obtaining the first data from the data provider, determining an aggregation function for the first data and a second data of a second field in the commenting layer and generating an aggregated data in the commenting layer by performing a data mashup operation on the first field and the second field based on the aggregation function.

In an embodiment, the data mashup performed includes performing aggregation functions such as sum, average, standard deviation and a user defined aggregating function. For example, a data mashup tool allows a user to add a new sales figure to a sales report and recalculate a total sales value. In another example, the data mashup tool allows the user to calculate and display a year to year sales variance in a sales report containing the details of the sales figure of an enterprise for the last year and current year.

### BRIEF DESCRIPTION OF THE DRAWINGS

FIG. 1 is a block diagram of a system for performing a data mashup in a commenting layer according to an embodiment of the invention.

FIG. 2 is a block diagram of a system to perform a data mashup in an enterprise application according to an embodiment of the invention described with reference to FIG. 1.

FIG. 3 is a flow diagram for performing a data mashup in commenting layer in a system described in FIG.1 according to an embodiment of the invention.

FIG. 4 is an example screen display of sales report generated by the system of FIG.2 on which a data mashup is performed according to an embodiment of the invention.

FIG. 5 is an example screen display of a data mashup tool for performing a data mashup in a commenting layer on data such as the sales report of FIG. 4 according to an embodiment of the invention.

FIG. 6 is an example screen display of a data mashup tool to perform data mashup in a commenting layer on data such as the sales report of FIG. 4 according to an embodiment of the invention.

### DETAILED DESCRIPTION

Described are methods and systems for receiving an instruction for data mashup in a commenting layer. The method includes generating a list of fields in the commenting layer available for the data mashup, receiving a user selection for a first field from the list of fields, determining a data provider to provide a first data of the first field, obtaining the first data from the data provider. After obtaining the first data, an aggregation function is determined for the first data and a second data of a second field in the commenting layer. Finally, an aggregated data is generated in the commenting layer by performing a data mashup operation on the first field and the second field based on the aggregation function.

In one embodiment, the data mashup performed includes performing aggregation functions such as sum, average, standard deviation and a user defined aggregation function. The user defined aggregation function can be any function that can be performed on the selected data field operands including some combination of the operations enumerated above. For example, the data mashup tool allows a user to add a new sales figure to a sales report and recalculate a total sales value. In another example, the data mashup tool allows the user to calculate and display a year to year sales variance in a sales report containing the details of the sales figure of an enterprise for the last year and current year. In both the embodiments, the data mashup tool does not modify the original sales report schema; rather it displays the user added values and calculations on a commenting layer which uses data from the underlying original sales report.

Today a novice end user typically does not have access to complex enterprise mashup features such as aggregation functions on report data. Consider, for instance, a sales report containing sales figures of an organization in several countries and a sum total of the sales in these countries being displayed to a novice end user. Inspired by what he or she sees in such a report the end user may want to add a new field such as “Sales in Asia”, calculate sales of the countries in Asia and display it in the sales report. However, today the end user typically cannot do this without getting access to a report design tool and changing the report schema to add this aggregation. Many novice end users do not have such advanced skills. Also, the end user today cannot add a new field to the report or combine various reports into one report during runtime. Such features are typically offered only in tools that perform the data mashup during the design time. Therefore such features are typically available only to application developers and not to the end users.

Many data mashup tools are consumer focused, for instance, data mashup tools such as maps, blogs, and news. In an enterprise scenario it is very important to view various kinds of data such as customer information, sales information, stock information, customer sales history, and country wise profit for performing various studies and analyses. The user may choose to view such data and compare it with his set of data for further analysis. But, the report generation software may not allow the user to input his set of data into the enterprise application. The data mashup tool explained below enables the user to perform a data mashup on data displayed in a presentation layer with the other set of data. The other set of data may be a user entered data or data fetched from various other enterprise applications.

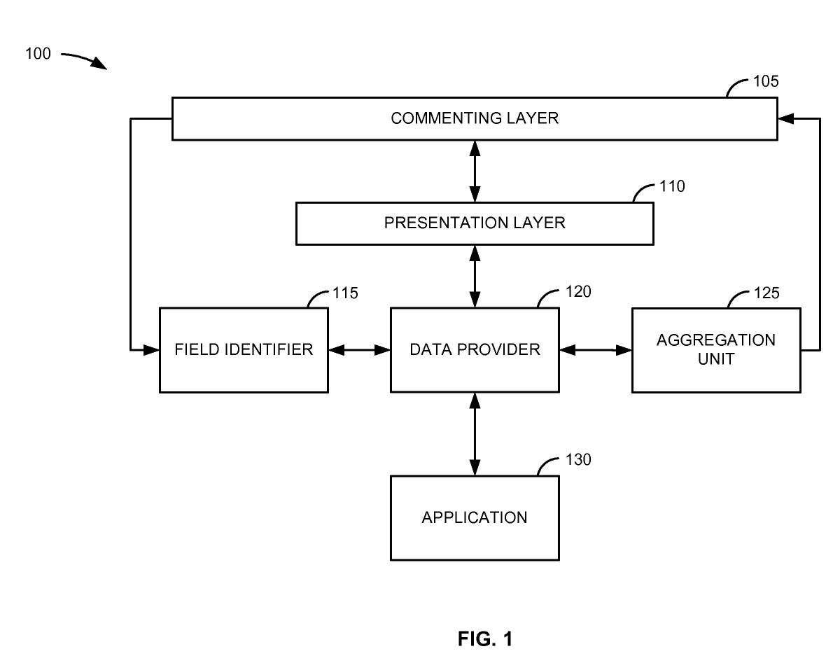

FIG. 1 is a block diagram of a system for performing a data mashup in a commenting layer according to an embodiment of the invention. System 100 includes commenting layer 105 that facilitates data mashup. The commenting layer 105 is a layer in addition to the presentation layer 110 that allows a user to perform data mashup on data displayed in presentation layer 110. For instance, the user may perform data mashup on a sales report displayed in presentation layer 110. The user may perform the data mashup on data displayed in presentation layer 110 with another set of data displayed in presentation layer 110, with other data not currently displayed in the presentation layer 110, with user specified data or some combination thereof. The limitations of presentation layer 110 do not allow the end user to perform the data mashup. Since presentation layer 110 is integrated with application 130, it typically does not allow the end user to modify the content of the data, add data, and remove data from the data displayed in presentation layer 110. To modify the content of the data displayed in presentation layer 110, a report schema in application 130 may have to be modified. This modification may not be possible if the end user does not have permission to modify the report schema in application 130. The commenting layer 105 overcomes the above limitations of presentation layer 110 and allows the user to select data displayed in presentation layer 110 for data mashup with another set of data. The commenting layer 105 allows the user to enter values for data mashup or obtain data from different sources which is otherwise not possible in presentation layer 110. The data mashup adds the user entered values on commenting layer 105, without modifying the original sales report.

Once the commenting layer 105 receives an instruction requesting a data mashup from a user, the field identifier 115 presents the user with a list of fields in the commenting layer 105 that are available for data mashup. The field identifier 115 requests data provider 120 to provide the list of fields displayed in presentation layer 110. On receiving a user selection of a first field from the list of fields, field identifier 115 determines data provider 120 that obtains at least a first data associated with the first field. Among other things, the data provider 120 specifies a data source for obtaining current values of the data associated with the first field. For determining data provider 120, field identifier 115 identifies a business object to which the first field belongs and then determines data provider 120 based on the business object. For example, if the first field is “Customer Name”, then the user selection for the first field reads as “Customer.CustomerName” implying that “CustomerName” is a field in business object “Customer”. The field identifier 115 obtains data provider 120 that can fetch data for “CustomerName” from the Customer business object. In one embodiment, the data provider 120 may be a web service. The web services represent self-contained, self-describing pieces of application functionality that can be accessed by other applications.

In one alternative embodiment, instead of retrieving data from an external data source, the user may also directly input data for the first field in commenting layer 105, in which case, data provider 120 may be commenting layer 105 itself. The field identifier 115 may also receive a user selection for a second field in commenting layer 105 and determine data provider 120 associated with a second data associated with the second field.

After data provider 120 is determined, aggregation unit 125 requests data provider 120 to provide the first data and the second data. The data provider 120 provides the first data and the second data to aggregation unit 125 by obtaining them from application 130. Accordingly, the application 130 is just one example of a source of data for data mashups. Data mashup can be implemented according to the principles described herein based on data from multiple different sources including many different applications such as the application 130. The data provider 120 may also obtain the first data and the second data from other sources such as commenting layer 105, a database, a file, a memory, etc. The aggregation is described above with reference to just two types or sources of data. However, such aggregation is possible with any number of different types and/or sources of data.

The aggregation unit 125 aggregates the first data and the second data based on an aggregation function to create an aggregated data in commenting layer 105. The aggregated data is obtained by performing a data mashup operation according to the aggregation function on the data of the first field and the second field. For instance, the data mashup operation includes adding a first field into commenting layer 105 then performing an aggregation function on the first data and the second data associated with a second field in the user interface. The aggregation functions provided by the commenting layer 105 include but are not limited to exemplary operations such as a sum, a difference, an average, a standard deviation and any other user defined aggregating function. The commenting layer 105 displays the aggregated data to the user via a user interface in presentation layer 110.

Before aggregating the first data and the second data, aggregation unit 125 analyzes the first data and the second data for correctness based on business logic defined in application 130. For example, in a sales scenario, aggregation unit 125 checks whether the data such as quantity of a product entered by the user is according to a quantity limit defined in application 130. If the quantity of the product entered is within the limit, aggregation unit 125 proceeds with the aggregation else the data mashup tool raises an error message indicating the incorrect quantity.

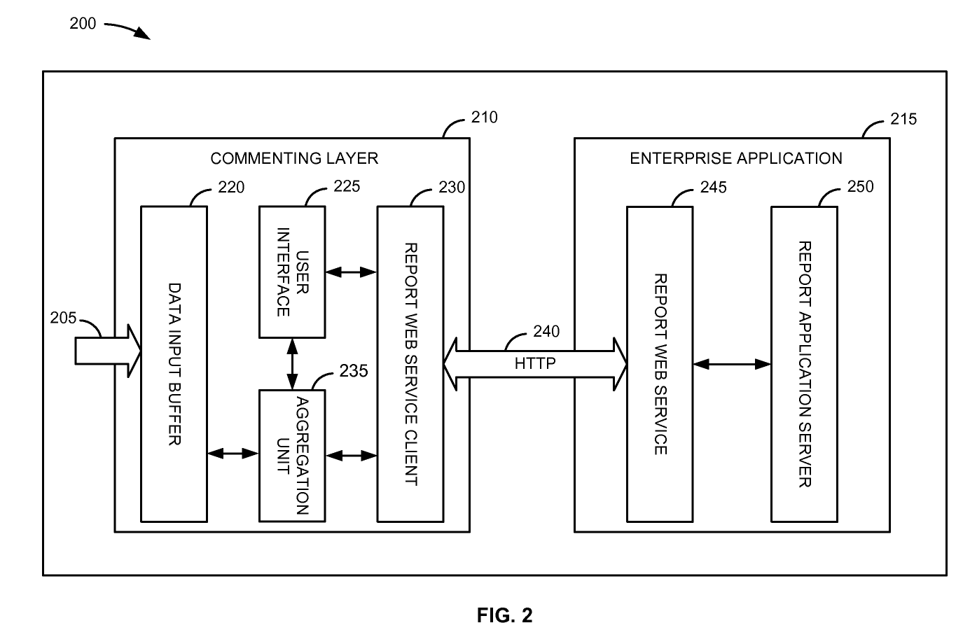

FIG. 2 is a block diagram of a system to perform a data mashup in an enterprise application according to an embodiment of the invention described with reference to FIG. 1. A system 200 is described herein with reference to a sales report which is used for the purposes of illustration only and should not be interpreted in any way to limit the scope of the invention. The system 200 includes user interface 225 in a client application that displays data such as a sales report of an organization obtained from enterprise application 215. The sales report may contain sales figures of the organization in various countries and a total sales figure which is the sum of the sales figures in various countries. The user may choose to modify the sales report displayed in user interface 225 to include data such as a sales figure of the organization in a new country and also recalculate a total sales value, for instance. Typically, this is not possible if the user does not have access to sales report creation software and enterprise application 215, or if they do not have the correct permissions to modify the report schema or data source.

A data mashup tool such as the one described with reference to system 200 makes it possible for the user to add the desired sales figure to the sales report displayed in user interface 225 by performing a data mashup in commenting layer 210. Advantageously, to perform the data mashup in commenting layer 210, the user need not have access to the sales report creation software or enterprise application 215. The data mashup tool allows the user to perform the data mashup operation such as adding the user entered sales figure 205 to the sales report displayed in user interface 225 and calculate a new total sales value by performing an aggregation function such as a sum of the user entered sales figure 205 and total sales.

On receiving an instruction for data mashup, system 200 generates a list of fields in commenting layer 210 available for data mashup. For instance, if the user inputs sales figure 205 of a new country as a first data and selects the sales report as the second data, commenting layer 210 receives sales figure 205 in data input buffer 220. After receiving the user entered sales figure 205 and the user selection for the sales report, aggregation unit 235 requests the data input buffer 220 and report web service client 230 to provide the sales figure 205 and the sales report respectively. The report web service client 230 obtains the sales report from enterprise application 215 through report web service 245. The report web service client 230 sends the request to the report web service 245 via a hyper text transfer protocol (HTTP) 240. The report web service 245 responds to the request by fetching the sales report from report application server 250. The report web service client 230 submits the sales report to aggregation unit 235.

The aggregation unit 235 analyzes the user entered sales figure 205 for its correctness based on business logic defined in enterprise application 215 and then performs a data mashup. The aggregation unit 235 aggregates the user entered sales figure 205 based on the aggregation function defined by the user and displays the user entered sales figure 205 in commenting layer. The sales figure 205 of the new country and a new total sales figure are contained in the commenting layer. The new total sales figure is a sum of previous total sales figure and the user entered sales figure 205. The aggregated sales report is displayed in user interface 225. Parts of the system of FIG. 2 are described as performing different functionalities for the purposes of illustration only. However, these functions can be distributed among the various parts illustrated in FIG. 2 or consolidated within fewer parts as needed based on implementation choices.

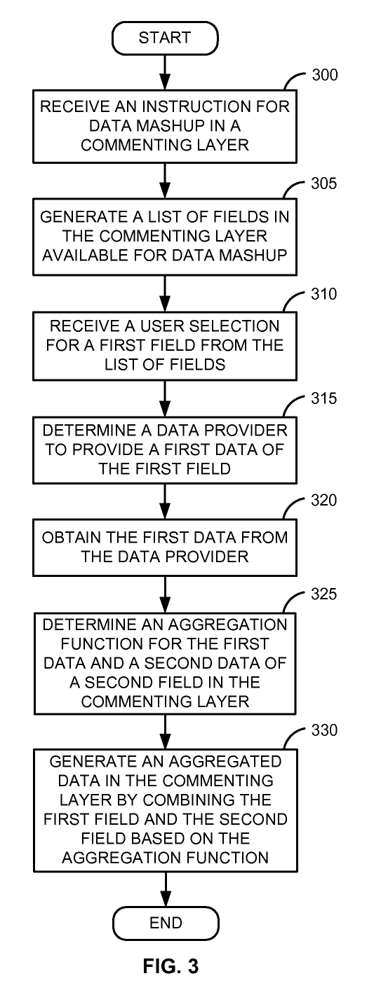

FIG. 3 is a flow diagram for performing a data mashup in commenting layer in a system described in FIG. 1 according to an embodiment of the invention. At step 300, an instruction for data mashup in commenting layer 105 is received by commenting layer 105. The commenting layer 105 is a layer on top of presentation layer 110 that provides data mashup functionality and receives user selection of data for data mashup.

At step 305, a list of fields in commenting layer 105 available for data mashup are generated by field identifier 115. At step 310, a user selection for a first field from the list of fields is received by field identifier 115. Similarly, the user selection for a second field is also received. After the user selection for the first field is received, at step 315, a data provider 120 that can obtain a first data of the first field is determined. For example, if the first data is input by the user in commenting layer 105, then commenting layer 105 is determined as data provider 120. If the first data is obtained from another source such as application 130, field identifier 115 obtains a web service that can act as data provider 120 for the first data. For example, if the first data is a sales report data, then a sales report web service is identified as data provider 120 to provide sales report data.

At step 320, aggregation unit 125 obtains the first data from data provider 120. Similarly, aggregation unit 125 also requests a second data of the second field from data provider 120. At step 325, an aggregation function is determined for the first data and the second data. Examples of aggregation type include sum, difference, average, maximum, minimum, standard deviation, and variance. Finally, at step 330, an aggregated data is generated in commenting layer 105 by performing a data mashup operation on the first field and the second field based on a selected aggregation function. The aggregated data is displayed to the user via presentation layer 110.

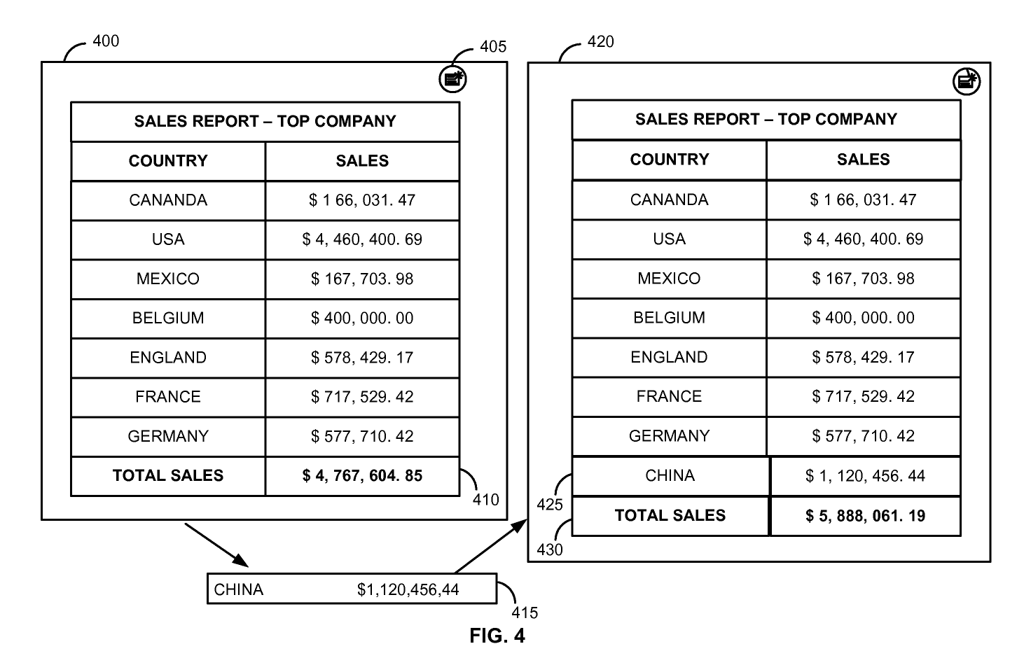

FIG. 4 is an example screen display of sales report generated by the system of FIG. 2 on which a data mashup is performed according to an embodiment of the invention. Sales report 400 is a report containing sales figure in various countries for an organization called “Top Company.” Sales report 400 includes sales figure of “Top Company” in countries such as “Canada”, “USA”, “Mexico”, “Belgium”, “England”, “France”, and “Germany”. The sales report 400 also includes “Total” sales figure which is a sum of the sales in the above mentioned countries. An aggregated sales report 420 is generated after a data mashup operation is performed on sales report 400.

The sales report 400 is displayed in user interface 225. For some reason, a user may choose to add new data such as sales figure of China 415 to sales report 400. The user would not be able to do it if sales figure of China 415 is not provided by enterprise application 215. Also, the user may not be able to do it if he does not have sufficient permissions to add sales figure of China 415 to enterprise application 215 or to change the report schema. But, the user may add the sales figure of China 415 to sales report 400 by doing a data mashup in commenting layer 210. The user may switch to data mashup tool by triggering an event in sales report 400. For example, the user may press a button 405 in sales report 400 to switch to data mashup tool. The user may input sales figure of China 415 in commenting layer 210 as a first field and may specify to add sales figure of China 415 to commenting layer 210. The user may also specify total sales 410 field in sales report 400 as a second field. The user may also define an aggregation function such as a sum which calculates a sum of the sales figure of China 415 and total sales 410.

The aggregation unit 235 receives sales report 400 from report web service client 230 and receives sales figure of China 415 from data input buffer 205 in commenting layer 210. The aggregation unit 235 performs a data mashup operation by adding sales figure of China 425 to sales report 420 in commenting layer 210. The aggregation unit 235 also performs an aggregation function to recalculate total sales figure 430 which is sum of total sales 410 and sales figure of China 415. The aggregation unit 235 generates an aggregated sales report 420 that includes sales figure of China 425 with a value “CHINA $1,120,456.34” and total sales 430 with a value “TOTAL SALES $5,888,061.19” in commenting layer 210. The aggregated sales report 420 is displayed in user interface 225.

In an embodiment, the data mashup tool may perform data mashup on current data displayed in the presentation layer such as the sales report 400 with
a user input data in commenting layer 210 or
data fetched from the enterprise application 215 or
a combination of the user input data and data fetched from enterprise application 215.
   For example, the data mashup tool may perform a data mashup on a sales report containing sales figures for current year with another sales report containing sales figure for previous year to calculate and display a year on year revenue variance.

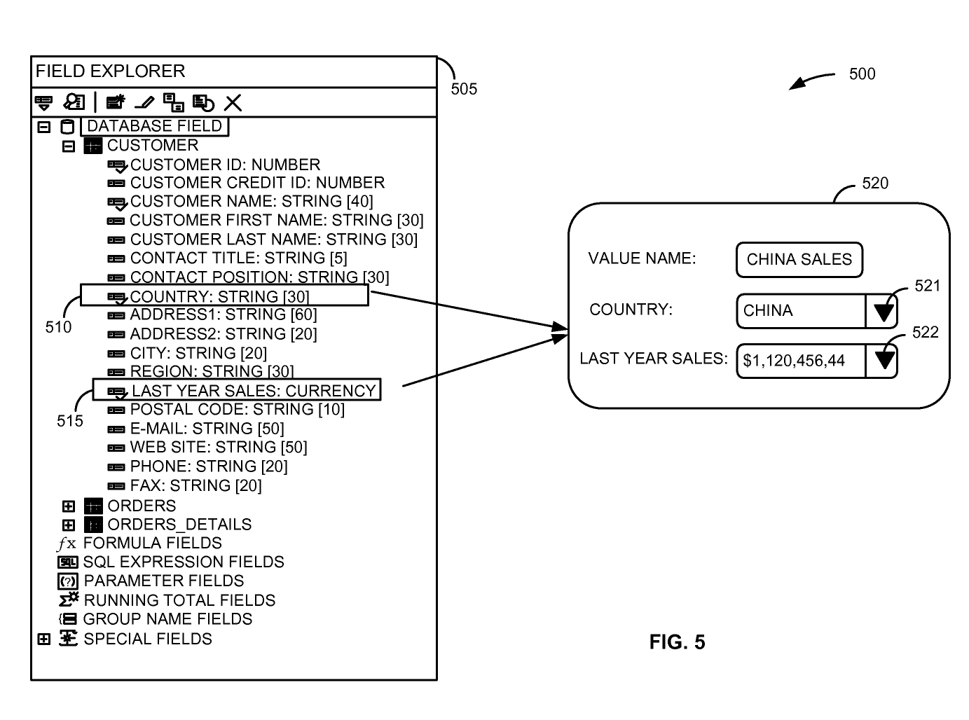

FIG. 5 is an example screen display of a data mashup tool for performing data mashup in a commenting layer on data such as the sales report of FIG. 4 according to an embodiment of the invention. Data mashup view 500 displays a data mashup tool to perform a data mashup between user entered sales figure of China 415 and sales report 400 in the commenting layer. The user may switch to data mashup view 500 by triggering an event in sales report 400 such as pressing a button 405. In data mashup view 500, field explorer 505 displays the fields of sales report 400 that are available for data mashup. The fields country 510 and last year sales 515 are chosen for the data mashup. The user may enter data for the fields country 510 and last year sales 515 in input box 520 as “China” and “$1,120,456.44” respectively. Alternatively, the user may fetch the values for the fields country 510 and last year sales 515 from another source of data such as enterprise application, another report, or database using country drop down menu 521 and sales drop down menu 522. The data mashup tool performs a data mashup operation by adding sales figure of China 425 entered in input box 520 to sales report 420 in the commenting layer.

Typically, users who do not have access to an enterprise application that generates the sales report may not be able to modify the sales report. Data mashup tool 500 enables even the most basic user who only has read access for the sales report to modify the sales report by performing a data mashup in the commenting layer. Typically, the data mashup tool may be integrated in software applications. For example, a web browser, Java application and .NET application. The software application may be configured to enable or disable the data mashup tool.

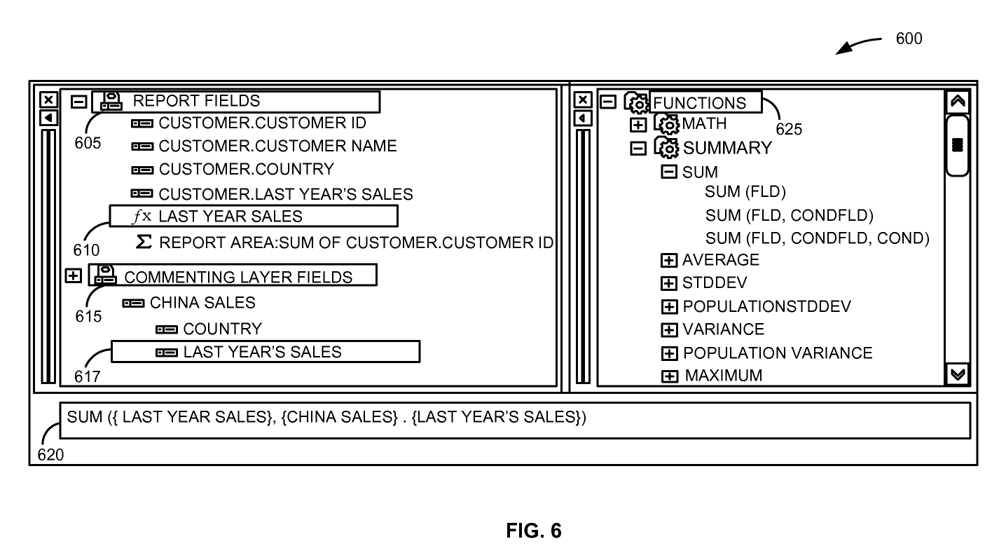

FIG. 6 is an example screen display of a data mashup tool to perform data mashup in a commenting layer on data such as the sales report of FIG. 4 according to an embodiment of the invention. Data Mashup view 600 displays a data mashup tool to perform an aggregation function including but not limited to sum, variance, difference, maximum, minimum and variance. Report fields 605 contain fields that are displayed in sales report 400 and commenting layer fields 615 contains fields such as sales figure of China 415 that are entered in commenting layer by the user. The user may add more fields, remove fields or modify fields in the commenting layer fields 615. For instance, the user may right click on commenting layer fields 615 and choose a data mashup operation such as add field, remove field and modify field from a context menu. Functions 625 include the aggregation functions that are provided by the data mashup tool in the commenting layer. Other functions can be defined by the user and added to the enumerated list.

After entering the sales figure of China 415, the user may define an aggregation function 620 for total sales figure 410 and sales figure of China 415. The aggregation function 620 “Sum (Last Year Sales, (China Sales).Last Year Sales)” recalculates total sales figure 430 by performing a sum of fx last year sales 610 and last year sales of China 617 which is a sum of total sales figure 410 and sales figure of China 415 respectively. The recalculated total sales figure 430 is displayed in sales report 420. The user may view the aggregated sales report 420 including total sales 430 by returning to the sales report 420.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components. A general-purpose computer includes a processor, memory, and other conventional hardware. As one skilled in the art will appreciate, the methods or systems described above can be implemented in program code that is executed by the processor to accomplish the described functions.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other types of tangible machine-readable media suitable for storing electronic instructions. For example, the present invention may be downloaded as a computer program which may be transferred from a remote computer (e.g., a server) to a requesting computer (e.g., a client) by way of a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. A computer implemented method for data mashup in a commenting layer, comprising:
receiving an instruction for data mashup in a commenting layer;
generating a list of fields in the commenting layer available for the data mashup;
receiving a user selection for a first field from the list of fields;
determining a data provider to provide a first data of the first field;
obtaining the first data from the data provider;
determining an aggregation function for the first data and a second data of a second field in the commenting layer; and
generating an aggregated data in the commenting layer by performing a data mashup operation on the first field and the second field based on the aggregation function.

2. The method in claim 1, further comprising generating a user interface to display the aggregated data.

3. The method in claim 1, wherein determining a data provider to provide a first data comprises identifying a business object to which the first field belongs.

4. The method in claim 1, wherein the data mashup operation comprises an operation selected from a group consisting of inserting, deleting, and modifying the first field.

5. The method in claim 1 further comprising analyzing the first data for correctness based on business logic.

6. The method in claim 1, wherein the aggregation function comprises a function selected from a group consisting of a sum, a difference, a multiplication, a quotient, a median, an average, a standard deviation, a variance, a maximum, a minimum and a user defined aggregation.

7. The method in claim 6, wherein the aggregation function is provided by the commenting layer for selection.

8. The method in claim 1, wherein the first data comprises data input by a user in the commenting layer.

9. The method in claim 8 further comprising analyzing the user input first data for correctness based on business logic

10. The method in claim 1, wherein the first data comprises data obtained by the data provider from an application.

11. The method in claim 1, wherein the data provider comprises a web service.

12. The method in claim 1 further comprising obtaining business logic from an application through a web service.

13. A computer system including a processor and a memory, the memory comprising instructions that are executable by the processor, the instructions comprising:
a commenting layer to receive an instruction for data mashup;
a field identifier in communication with the commenting layer to receive a user selection of a first field for the data mashup;
a data provider in communication with the field identifier to obtain a first data of the first field;
an aggregation unit in communication with the data provider to perform an aggregation function for the first data and a second data of a second field in the commenting layer; and
a presentation layer in communication with the commenting layer to display an aggregated data.

14. The system in claim 13, wherein the data provider comprises a web service in communication with an application.

15. The system in claim 14 further comprising a web service client in communication with the web service to obtain data from an application.

16. The system in claim 15, wherein the web service client communicates with the web service over a communication network via hyper text transfer protocol.

17. An article of manufacture, comprising:
a machine readable medium having instructions which when executed by a machine cause the machine to perform operations comprising:
receiving an instruction for data mashup in a commenting layer;
generating a list of fields in the commenting layer available for the data mashup;
receiving a user selection for a first field from the list of fields;
determining a data provider to provide a first data of the first field;
obtaining the first data from the data provider;
determining an aggregation function for the first data and a second data of a second field in the commenting layer; and
generating an aggregated data in the commenting layer by performing a data mashup operation on the first field and the second field based on the aggregation function.

18. The article of manufacture in claim 17, wherein the machine readable medium further comprises instructions to identify a business object to which the first field belongs.

19. The article of manufacture in claim 17, wherein the machine readable medium further comprises instructions to analyze the first data for correctness based on business logic.

20. The article of manufacture in claim 17, wherein the machine readable medium further comprises instructions to obtain business logic from an application.
